(19) United States
(12) Patent Application Publication
(10) Pub. No.: US 2025/0384529 A1
(43) Pub. Date: Dec. 18, 2025

(54) METHOD AND APPARATUS FOR TRAINING IMAGE-ENHANCED NEURAL NETWORK MODEL

(71) Applicant: Nextchip Co., Ltd., Seoul (KR)

(72) Inventor: E Woo CHON, Seoul (KR)

(73) Assignee: Nextchip Co., Ltd., Seoul, KG (KR)

(21) Appl. No.: 18/878,726

(22) PCT Filed: Mar. 23, 2023
(86) PCT No.: PCT/KR2023/003877

§ 371 Date: Dec. 24, 2024

(30) Foreign Application Priority Data
Jan. 17, 2022 (KR) 10-2022-0102817

(51) Int. Cl. G06T 5/60

(52) U.S. Cl. CPC G06T 5/60; G06T 2207/20081; G06T 2207/20084; G06T 2207/20172

(57) ABSTRACT

A method and an apparatus for training an image-enhanced neural network model are provided. According to one embodiment, the training method may comprise the steps of: acquiring sample images having various image qualities; generating enhanced images of at least some of the sample images by using image enhancement software having an image enhancement function; constructing, from the sample images and the enhanced images, training data that forms pairs of input data and target data; using the training data so as to output an enhanced output image in response to input of a low-image-quality input image; and performing supervised training on a first neural network model for outputting a corresponding-image-quality output image in response to input of a high-image-quality input image.

### TECHNICAL FIELD

The following embodiments relate to a method and apparatus for training an image enhancement neural network model.

### BACKGROUND ART

Image enhancement may correspond to the task of improving the quality of the original image. Image enhancement algorithms may include traditional filtering methods and machine learning methods. The traditional filtering methods may include real-time algorithms and non-real-time algorithms, and the machine learning methods may include unsupervised learning and supervised learning. A neural network may be trained based on deep learning and then perform inferences suitable for the purpose by mapping input data and output data in a nonlinear relationship to each other. The trained ability to generate such a mapping may be called the learning ability of the neural network.

### DISCLOSURE OF THE INVENTION

### Technical Solutions

According to an embodiment, a training method includes acquiring sample images of various qualities; generating enhanced images of at least some of the sample images using image enhancement software having an image enhancement function; constructing, from the sample images and the enhanced images, training data that forms pairs of input data and target data; and performing, using the training data, supervised learning of a first neural network model to output an enhanced output image in response to a low-quality input image being input and output a corresponding quality output image in response to a high-quality input image being input.

The sample images may include first sample images captured by a first camera of a first class and second sample images captured by a second camera of the first class, and the enhanced images may include first enhanced images corresponding to at least some of the first sample images and second enhanced images corresponding to at least some of the second sample images.

The sample images may include third sample images captured by a third camera of a second class, the enhanced images may include third enhanced images corresponding to at least some of the third sample images, and the training method may further include performing, using training data according to the third sample images and the third enhanced images, supervised learning of a second neural network model to output an enhanced output image in response to a low-quality input image being input and output a corresponding quality output image in response to a high-quality input image being input.

The first neural network model may be used for real-time image enhancement of cameras of the first class, and the second neural network model may be used for real-time image enhancement of cameras of the second class.

The performing of supervised learning may include adjusting parameters of the first neural network model to reduce a difference between the target data and output data corresponding to an output of the first neural network model according to an input of the input data.

The image enhancement software may be software configured to generate the enhanced images from the sample images in non-real time.

According to an embodiment, a training apparatus includes a processor; and a memory including instructions executable by the processor, wherein when the instructions are executed by the processor, the processor may be configured to acquire sample images of various qualities, generate enhanced images of at least some of the sample images using image enhancement software having an image enhancement function, construct, from the sample images and the enhanced images, training data that forms pairs of input data and target data, and perform, using the training data, supervised learning of a first neural network model to output an enhanced output image in response to a low-quality input image being input and output a corresponding quality output image in response to a high-quality input image being input.

The sample images may include first sample images captured by a first camera of a first class and second sample images captured by a second camera of the first class, and the enhanced images may include first enhanced images corresponding to at least some of the first sample images and second enhanced images corresponding to at least some of the second sample images.

The sample images may include third sample images captured by a third camera of a second class, the enhanced images may include third enhanced images corresponding to at least some of the third sample images, the processor may be configured to perform, using training data according to the third sample images and the third enhanced images, supervised learning of a second neural network model to output an enhanced output image in response to a low-quality input image being input and output a corresponding quality output image in response to a high-quality input image being input, the first neural network model may be used for real-time image enhancement of cameras of the first class, and the second neural network model may be used for real-time image enhancement of cameras of the second class.

### BRIEF DESCRIPTION OF DRAWINGS

FIG. 1 is a flowchart exemplarily illustrating an overall process of training and inference of a neural network model according to an embodiment.

FIG. 2 is a table illustrating a comparison of the characteristics of various image enhancement methods.

FIG. 3 is a diagram illustrating a process of constructing a training DB using a camera of a feature class according to an embodiment.

FIG. 4 is a diagram illustrating a process of constructing a training DB using multiple cameras of multiple classes according to an embodiment.

FIG. 5 is a block diagram illustrating a configuration of a training apparatus according to an embodiment.

FIG. 6 is a flowchart illustrating a training method according to an embodiment.

### BEST MODE FOR CARRYING OUT THE INVENTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components, and any repeated description related thereto will be omitted.

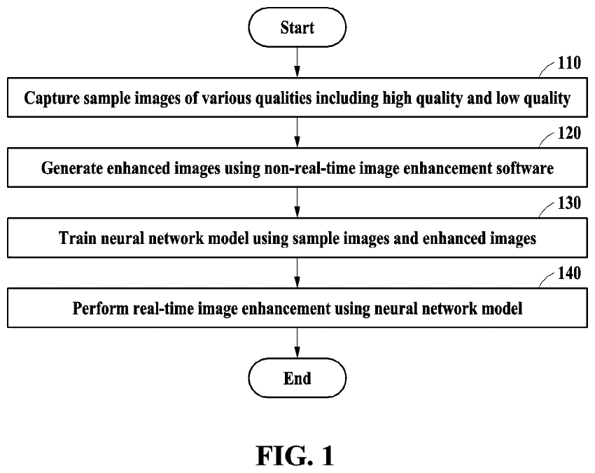

FIG. 1 is a flowchart exemplarily illustrating an overall process of training and inference of a neural network model according to an embodiment. Referring to FIG. 1, in operation, sample images of various qualities including high quality and low quality are captured. The sample images may refer to images used to train a neural network model. A low-quality image may be an image of a low quality including noise, blur, and the like. The low-quality image may be captured in a low-quality environment. The low-quality environment may be an environment in which it is difficult to acquire an image of the desired quality, such as a low-luminance environment. Details of the low-quality environment may be pre-defined.

In operation 120, enhanced images are generated using non-real-time image enhancement software. Enhanced images of at least some of the sample images of the various qualities may be generated. For example, the enhanced image may be generated for both high-quality images and low-quality images. In this case, the enhanced images of the low-quality images may be generated by enhancing the qualities of the low-quality images greatly, and the enhanced image of the high-quality images may be generated without changing the qualities of the high-quality images greatly. As another example, the enhanced image may be generated selectively for the low-quality images among the sample images.

Image enhancement software may be different from a filter-based real-time image enhancement algorithm using various filters. For example, the filters may include filters of various designs such as a low-pass filter and a smooth filter. For example, the image enhancement software may include a variety of software for enhancing the quality of an image in non-real time, such as Photoshop, NoiseWare, and Capture One. The image enhancement software may enhance low-quality images according to a predetermined image enhancement algorithm without direct editing by humans.

The image enhancement software may require more time for driving, edition, and result generation, than the filter-based real-time image enhancement algorithm and thus, may not satisfy real-time performance, but may provide better enhanced results than when a filter is used. The filter-based method may use various high-performance algorithms due to the constraints of real-time performance and thus, may have difficulties in achieving high performance accordingly. According to embodiments, using a neural network model for image enhancement may secure real-time image enhancement. In this case, the process of training the neural network model may not need to be performed in real time, but may require an exquisitely modeled training database (DB) instead, and thus, a training DB may be constructed through the image enhancement software rather than the filter-based method.

In operation 130, a neural network model may be trained using the sample images and the enhanced images. The sample images may be used as input data of the neural network model, and the enhanced images may correspond to target data of the neural network model. If the qualities of the low-quality images and the high-quality images are enhanced, the input data may include the low-quality images and the high-quality images, and the target data may include enhanced images respectively corresponding thereto. If the qualities of the low-quality images are enhanced selectively, the input data may include the low-quality images and the high-quality images, and the target data may include enhanced images of the low-quality images and the same high-quality images.

The target data may correspond to the training target and may be referred to as ground truths (GTs) or labels. The neural network model may output the output data in response to the input data being input, and training may be performed to reduce the difference between the target data and the output data. For example, parameters (e.g., weights) of the network model may be adjusted to reduce the difference between the target data and the output data.

Training methods include supervised learning and unsupervised learning, and the method described above may correspond to supervised learning. Supervised learning and unsupervised learning are different in whether a GT is necessary. Unsupervised learning does not require a GT, and the absence of a GT may lead to learning in unintended directions. Supervised learning requires a GT, and the method of modeling the training DB may greatly affect the performance of the neural network model.

According to embodiments, a method of acquiring sample images (e.g., low-quality images) and securing a GT by enhancing the sample images using image enhancement software is used. In contrast, there may be a method of acquiring high-quality images (e.g., images without noise) and securing a training DB by generating low-quality images (e.g., noisy images) through a degradation model (e.g., a noise model). In this case, the degradation model may be based on a noise model such as Gaussian, Poisson, or white noise. Such degradation models are merely estimation models for degradation phenomena and may not be considered to reflect the actual degradation phenomena. Thus, these methods may cause a decrease in the image enhancement performance. In contrast, the method according to embodiments actually uses low-quality images and thus, may exhibit high performance.

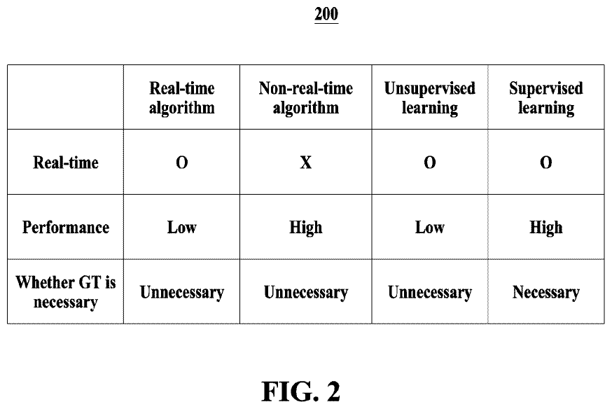

FIG. 2 is a table illustrating a comparison of the characteristics of various image enhancement methods. Referring to FIG. 2, a real-time algorithm using a filtering model is performed in real time but has a relatively lower performance, whereas a non-real-time algorithm using image enhancement software is not performed in real time but has a relatively high performance. The real-time algorithm and the non-real-time algorithm are not machine learning methods and thus do not require a GT. A neural network model to which unsupervised learning or supervised learning is applied estimates output data for input data in a short period of time and thus has real-time performance. Unsupervised learning does not require a GT, and the absence of a GT may lead to low performance unintentionally. Supervised learning requires a GT, and constructing a training DB close to degraded and enhanced results of actual images may result in high performance. Embodiments may provide a real-time, high-performance training method for easily obtaining a GT by combining supervised learning and a non-real-time algorithm.

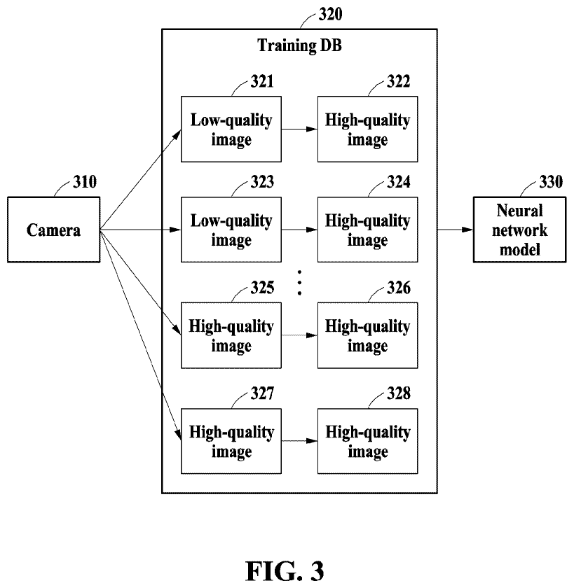

FIG. 3 is a diagram illustrating a process of constructing a training DB using a camera of a feature class according to an embodiment. Referring to FIG. 3, a camera 310 may capture low-quality images 321 and 323 and high-quality images 325 and 327, and image enhancement software may enhance at least some of the images 321, 323, 325, and 327 through a non-real-time algorithm. The low-quality images 321 and 232 may be enhanced to high-quality images 322 and 324. The high-quality images 325 and 327 may be enhanced to high-quality images 326 and 328 or maintained as are.

The image enhancement software may cause a significant difference between the low-quality images 321 and 323 and the high-quality images 322 and 324. When the high-quality images 325 and 327 are enhanced, there may be little difference between the high-quality images 325 and 327 and the high-quality images 326 and 328. That is, the high-quality images 322 and 324 may be high in quality compared to the low-quality images 321 and 323, and the high-quality images 325 and 327 may have qualities corresponding to those of the high-quality images 322, 324, 326, and 328. The images 321 to 328 may construct a training DB 320. The high-quality images 322, 324, 326, and 328 may correspond to training GTs. A neural network model 330 may be trained according to supervised learning based on the training DB 320.

The neural network model 330 may be applied to the output of the camera 310 after training is completed. When a low-quality image is input, the neural network model 330 may enhance the low-quality image and output an enhanced image, and when a high-quality image is input, the neural network model 330 may output the high-quality image with almost no correction. Accordingly, only images requiring enhancement in noise or brightness, among the outputs of the camera, may be enhanced in real time without human intervention, and images not requiring enhancement may be scarcely enhanced.

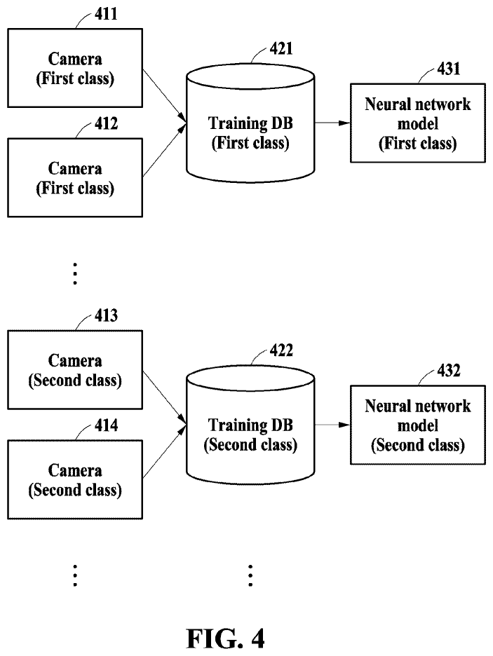

FIG. 4 is a diagram illustrating a process of constructing a training DB using multiple cameras of multiple classes according to an embodiment. To train a neural network model by appropriately reflecting the characteristics of images captured by a camera, the process of acquiring low-quality images, constructing a training DB, and supervised learning may need to be applied to each type of camera. This is because the neural network model may be trained properly for a predetermined camera only when images actually captured by the camera are used in the training process. At this time, cameras of the same class may be assumed to be the same camera, and training may be performed for each camera class accordingly. For example, the same class may indicate cameras belonging to the same class, such as the same type or the same model.

Referring to FIG. 4, a training DB 421 may be constructed with sample images captured by cameras 411 and 412 of a first class and enhanced images for the sample images from image enhancement software, and a training DB 422 may be constructed with sample images captured by cameras 413 and 414 of a second class and enhanced images for the sample images from the image enhancement software. A neural network model 431 may be trained using the training DB 421, and a neural network model 432 may be trained using the training DB 422. The neural network model 431 may be used to enhance images captured by the cameras of the first class, and the neural network model 432 may be used to enhance images captured by the cameras of the second class.

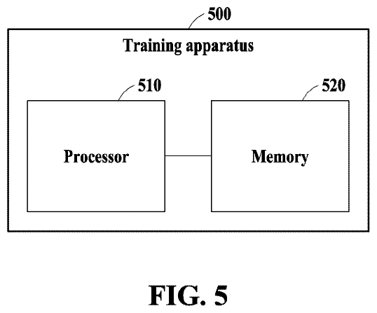

FIG. 5 is a block diagram illustrating a configuration of a training apparatus according to an embodiment. A training apparatus 500 includes a processor 510 and a memory 520. The memory 520 may be connected to the processor 510, and may store instructions executable by the processor 510, data to be computed by the processor 510, or data processed by the processor 510. The memory 520 may include a non-transitory computer readable medium, for example, a high-speed random-access memory, and/or a non-volatile computer readable storage medium (for example, one or more disk storage devices, flash memory devices, or other non-volatile solid state memory devices).

The processor 510 may execute instructions to perform the operations of FIGS. 1 to 4, and FIG. 6. For example, the processor 510 may acquire sample images of various qualities, generate enhanced images of at least some of the sample images using image enhancement software having an image enhancement function, construct, from the sample images and the enhanced images, training data that forms pairs of input data and target data, and perform, using the training data, supervised learning of a first neural network model to output an enhanced output image in response to a low-quality input image being input and output a corresponding quality output image in response to a high-quality input image being input. In addition, the description provided with reference to FIGS. 1 to 4 and FIG. 6 may apply to the training apparatus 500.

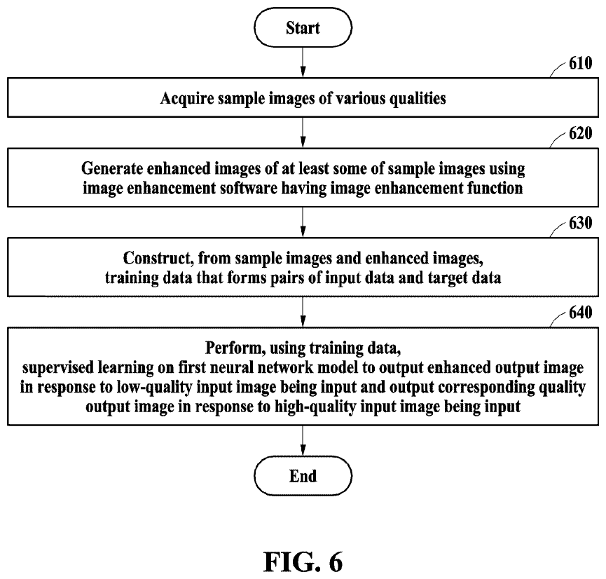

FIG. 6 is a flowchart illustrating a training method according to an embodiment. Referring to FIG. 6, a training apparatus according to an embodiment may perform operation 610 of acquiring sample images of various qualities, operation 620 of generating enhanced images of at least some of the sample images using image enhancement software having an image enhancement function, operation 630 of constructing, from the sample images and the enhanced images, training data that forms pairs of input data and target data, and operation 640 of performing, using the training data, supervised learning of a first neural network model to output an enhanced output image in response to a low-quality input image being input and output a corresponding quality output image in response to a high-quality input image being input.

According to an embodiment, the sample images may include first sample images captured by a first camera of a first class and second sample images captured by a second camera of the first class, and the enhanced images may include first enhanced images corresponding to at least some of the first sample images and second enhanced images corresponding to at least some of the second sample images.

According to an embodiment, the sample images may include third sample images captured by a third camera of a second class, the enhanced images may include third enhanced images corresponding to at least some of the third sample images, and the training apparatus may perform, using training data according to the third sample images and the third enhanced images, supervised learning of a second neural network model to output an enhanced output image in response to a low-quality input image being input and output a corresponding quality output image in response to a high-quality input image being input. At this time, the first neural network model may be used for real-time image enhancement of cameras of the first class, and the second neural network model may be used for real-time image enhancement of cameras of the second class.

According to an embodiment, operation 630 may include adjusting parameters of the first neural network model to reduce a difference between the target data and output data corresponding to an output of the first neural network model according to an input of the input data.

According to an embodiment, the image enhancement software may be software configured to generate the enhanced images from the sample images in non-real time.

In addition, the description provided with reference to FIGS. 1 to 5 may apply to the training method of FIG. 6.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

A number of embodiments have been described above. Nevertheless, it should be understood that various modifications may be made to these embodiments. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

1. A training method comprising:
acquiring sample images of various qualities;
generating enhanced images of at least some of the sample images using image enhancement software having an image enhancement function;
constructing, from the sample images and the enhanced images, training data that forms pairs of input data and target data; and
performing, using the training data, supervised learning of a first neural network model to output an enhanced output image in response to a low-quality input image being input and output a corresponding quality output image in response to a high-quality input image being input.

2. The training method of claim 1, wherein the sample images comprise first sample images captured by a first camera of a first class and second sample images captured by a second camera of the first class, and the enhanced images comprise first enhanced images corresponding to at least some of the first sample images and second enhanced images corresponding to at least some of the second sample images.

3. The training method of claim 2, wherein
the sample images comprise third sample images captured by a third camera of a second class,
the enhanced images comprise third enhanced images corresponding to at least some of the third sample images, and
the training method further comprises performing, using training data according to the third sample images and the third enhanced images, supervised learning of a second neural network model to output an enhanced output image in response to a low-quality input image being input and output a corresponding quality output image in response to a high-quality input image being input.

4. The training method of claim 3, wherein
the first neural network model is used for real-time image enhancement of cameras of the first class, and
the second neural network model is used for real-time image enhancement of cameras of the second class.

5. The training method of claim 1, wherein
the performing of supervised learning comprises adjusting parameters of the first neural network model to reduce a difference between the target data and output data corresponding to an output of the first neural network model according to an input of the input data.

6. The training method of claim 1, wherein
the image enhancement software is software configured to generate the enhanced images from the sample images in non-real time.

7. A computer program stored in a computer-readable recording medium to execute the method of claim 1 in combination with hardware.

8. A training apparatus comprising:
a processor; and
a memory comprising instructions executable by the processor,
wherein when the instructions are executed by the processor, the processor is configured to:
acquire sample images of various qualities,
generate enhanced images of at least some of the sample images using image enhancement software having an image enhancement function,
construct, from the sample images and the enhanced images, training data that forms pairs of input data and target data, and
perform, using the training data, supervised learning of a first neural network model to output an enhanced output image in response to a low-quality input image being input and output a corresponding quality output image in response to a high-quality input image being input.

9. The training apparatus of claim 8, wherein
the sample images comprise first sample images captured by a first camera of a first class and second sample images captured by a second camera of the first class, and
the enhanced images comprise first enhanced images corresponding to at least some of the first sample images and second enhanced images corresponding to at least some of the second sample images.

10. The training apparatus of claim 9, wherein
the sample images comprise third sample images captured by a third camera of a second class,
the enhanced images comprise third enhanced images corresponding to at least some of the third sample images,
the processor is configured to perform, using training data according to the third sample images and the third enhanced images, supervised learning of a second neural network model to output an enhanced output image in response to a low-quality input image being input and output a corresponding quality output image in response to a high-quality input image being input,
the first neural network model is used for real-time image enhancement of cameras of the first class, and
the second neural network model is used for real-time image enhancement of cameras of the second class.
